(19) United States
(12) Patent Application Publication
(10) Pub. No.: US 2015/0338228 A1
(43) Pub. Date: Nov. 26, 2015

(54) ROUTE PLANNING METHOD AND ROUTE PLANNING SYSTEM

(71) Applicant: MITAC INTERNATIONAL CORP., Taoyuan City (TW)

(72) Inventor: Meng-Fang HSIEH, Taoyuan City (TW)

(73) Assignee: MITAC INTERNATIONAL CORP., Taoyuan City (TW)

(21) Appl. No.: 14/720,599

(22) Filed: May 22, 2015

(30) Foreign Application Priority Data
May 23, 2014 (TW) 103118082

(51) Int. Cl. G01C 21/36

(52) U.S. Cl. CPC G01C 21/3605

(57) ABSTRACT

A route planning method includes: displaying, by an output device, a map and an original route from a departure point to a destination through at least two intermediate points on the map, the intermediate points being selected from a plurality of points of interest that are pre-stored in a storage device; transmitting, by an input device, an input signal to the processor in response to a user selection of a priority one of the intermediate points; upon receipt of the input signal, planning, by a processor, a modified route passing sequentially through the departure point, the priority one of the intermediate points, the remaining one(s) of the intermediate points and the destination; and displaying, by the output device, the modified route on the map.

### CROSS-REFERENCE TO RELATED APPLICATION

This application claims priority to Taiwanese Application No. 103118082, file on May 23, 2014.

### FIELD

The disclosure relates to a route planning method and a route planning system, and more particularly to a route planning method and a route planning system for planning a modified route according to a user selection.

### BACKGROUND

For planning a route from a departure point to a destination through a plurality intermediate points (e.g., selected points of interest), a conventional route planning system usually provides a route that is the shortest path, or a path that bypasses heavy traffic flow so as to save the time for arriving at the destination. However, when it is desired to, for example, pass through priority one(s) of the intermediate points first, the conventional route planning system cannot adjust the route to meet user demand.

### SUMMARY

Therefore, an object of the disclosure is to provide a route planning method that can provide a modified route according to a user selection.

According to one aspect of the present disclosure, a route planning method is to be implemented by a route planning system. The route planning system includes a storage device, an input device, an output device, and a processor electrically connected to the input device and the output device. The route planning method includes the steps of:

a) displaying, by the output device, a map and an original route from a departure point to a destination through at least two intermediate points on the map, the intermediate points being selected from a plurality of points of interest that are pre-stored in the storage device;

b) transmitting, by the input device, an input signal to the processor in response to a user selection of a priority one of the intermediate points;

c) upon receipt of the input signal, planning, by the processor, a modified route passing sequentially through the departure point, the priority one of the intermediate points, the remaining one of the intermediate points and the destination; and

d) displaying, by the output device, the modified route on the map.

Another object of the present disclosure is to provide a route planning system for planning a modified route according to a user selection.

According to another aspect of the present disclosure, a route planning system includes a storage device, an output device, an input device and a processor. The storage device is configured to store a plurality of points of interest. The output device is configured to display a map, and an original route from a departure point to a destination through at least two intermediate points on the map. The intermediate points are selected from the points of interest. The input device is configured to allow a user selection of a priority one of the intermediate points, and to generate an input signal in response to the user selection. The processor is electrically connected to the input device and the output device, and is configured to, upon receipt of the input signal from the input device, plan a modified route passing sequentially through the departure point, the priority one of the intermediate points, the remaining one of the intermediate points and the destination.

### BRIEF DESCRIPTION OF THE DRAWINGS

Other features and advantages of the disclosure will become apparent in the following detailed description of the embodiment with reference to the accompanying drawings, of which:

FIG. 1 is a block diagram of the route planning system according to an embodiment of the present disclosure;

FIG. 2 is a flow chart illustrating steps of a route planning method according to the embodiment;

FIG. 3 is a schematic diagram illustrating an original route that passes through multiple intermediate points on a map;

FIG. 4 is a schematic diagram illustrating a user selection of an intermediate route that passes sequentially through two priority ones of the intermediate points;

FIG. 5 is a schematic diagram illustrating a modified route according to the user selection shown in FIG. 4;

FIG. 6 is a schematic diagram illustrating a user selection of a priority one of the intermediate points; and

FIG. 7 is a schematic diagram illustrating another modified route according to the user selection shown in FIG. 6.

### DETAILED DESCRIPTION

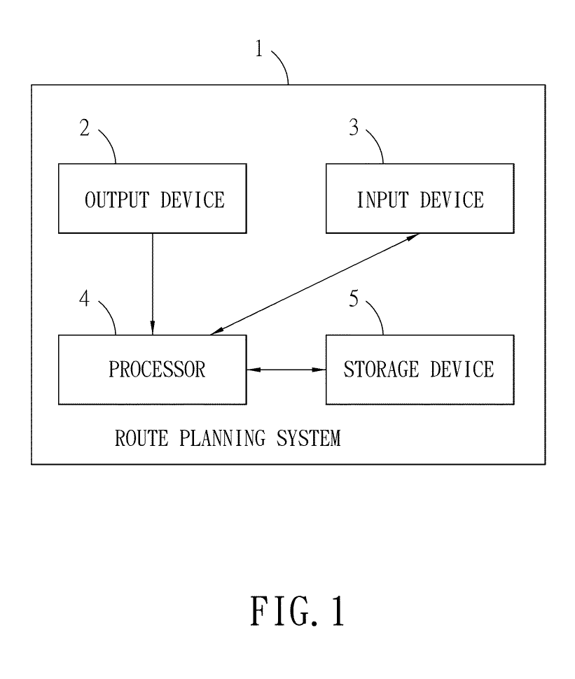

Referring to FIG. 1, the route planning system 1 according to the embodiment of this disclosure includes an output device 2, an input device 3, a processor 4 and a storage device 5. For example, the output device 2 is a display layer, and the input device 3 is a top sensing layer and is integrated with the output device 2 to form a touch screen.

The output device 2 is configured to display a map 100 and an original route 201 on the map 100 (see FIG. 3). The original route 201 is from a departure point 700 to a destination 705 through, for example, four intermediate points 701, 702, 703, 704 between the departure point 700 and the destination 705. The intermediate points 701, 702, 703, 704, for example, are selected from a plurality of points of interest (POI) that are pre-stored in the storage device 5.

The input device 3 is configured to allow a user selection of at least a priority one of the intermediate points 701-704, and to generate an input signal in response to the user selection. For example, a user may touch the touch screen at a position corresponding to one of the intermediate points 701-704, and the input device 3 generates, upon detecting the contact, an input signal indicating said one the intermediate points 701-704 as the priority one. Alternatively, the user may continuously touch the touch screen and move through multiple positions corresponding respectively to multiple ones of the intermediate points 701-704, and the input device 3, upon detecting the continuous contact, generates an input signal indicating said multiple ones of the intermediate points 701-704 as the priority ones.

The processor 4 is electrically connected to the input device 3 and the output device 2, and is configured to, upon receipt of the input signal from the input device 3, plan a modified route according to the user selection(s) as indicated by the input signal.

The storage device 5 is configured to further store the intermediate points 701-704 in a queue. The processor 4 is further electrically connected to the storage device 5, and is further configured to move the priority one (s) of the intermediate points 701-704 to the front in the queue, and plan the modified route according to the queue.

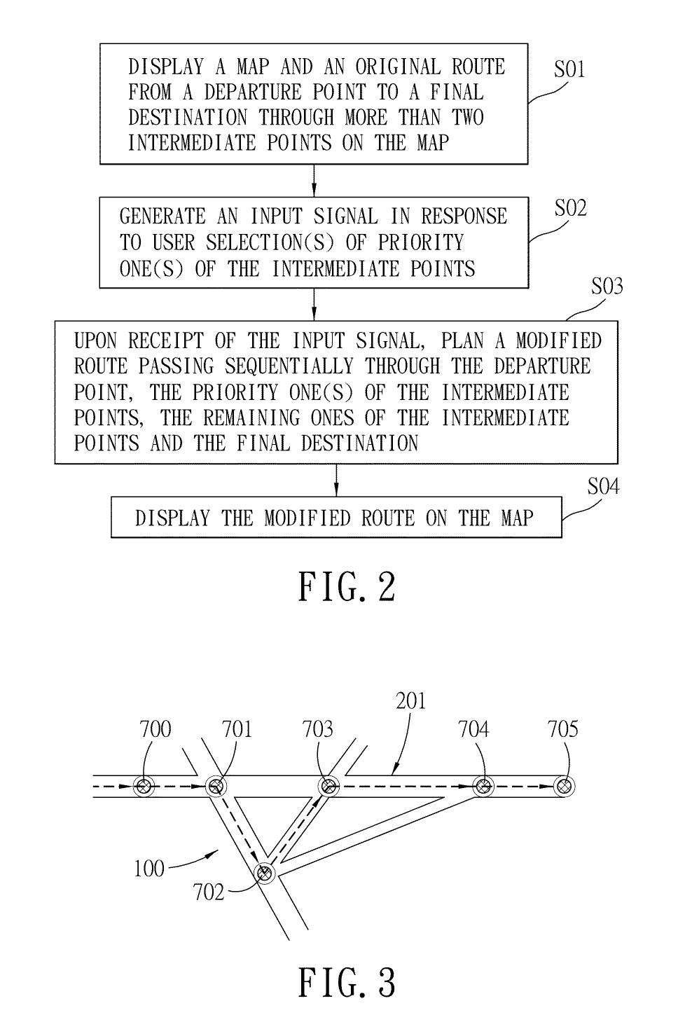

Referring to FIGS. 2 to 5, a route planning method to be implemented by the route planning system according to the embodiment of this disclosure is illustrated hereinafter.

In step S01, as shown in FIG. 3, the output device 3 displays the map 100 and the original route 201 from the departure point 700 to the destination 705 through the intermediate points 701-704 on the map 100.

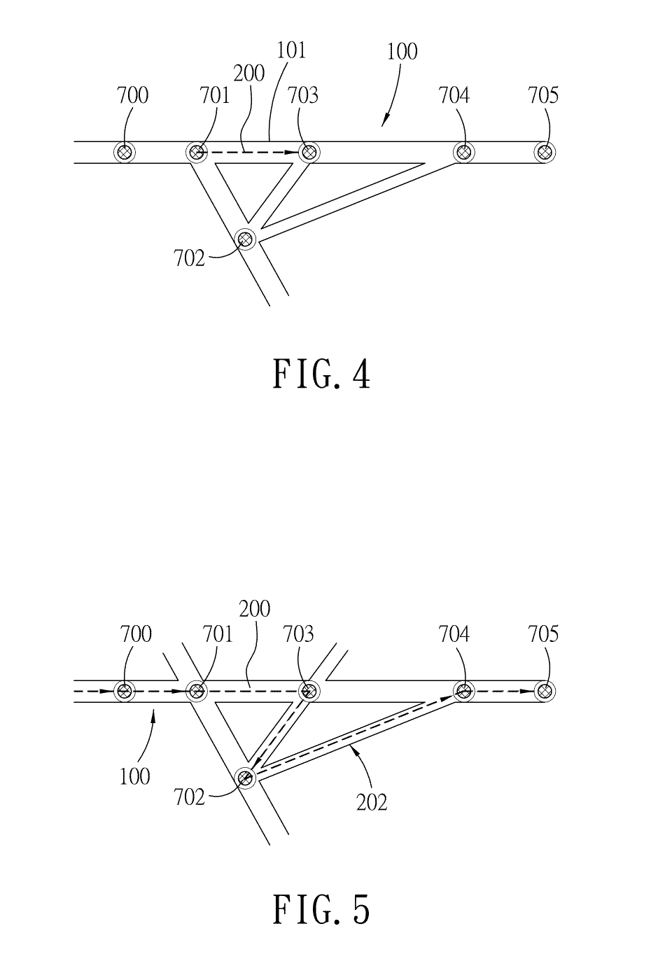

In step S02, the input device 2 generates an input signal and transmits the same to the processor 4 in response to the user selections respectively of multiple priority ones of the intermediate points 701-704. For example, referring to FIG. 4, when a user touches the input device 2 (i.e., the top sensing layer of the touch screen) and moves his/her finger (or stylus) along a motion path on the input device 2 from the intermediate point 701 to the intermediate point 703 to select the intermediate point 701, 703 as the priority ones of the intermediate points 701-704 in a selection order, the input device 2 in response transmits a corresponding input signal to the processor 4 upon detecting the continuous contact with the input device 2 moving from the intermediate point 701 to the intermediate point 703 along said motion path. Further, a route segment 101 on the map 100 displayed on the output device 2 and corresponding to the motion path of the continuous contact is selected as an intermediate route 200 that passes sequentially through the two priority ones of the intermediate points 701, 703 in the selection order. Accordingly, the input signal indicates the selection order of the user selections of the two priority ones of the intermediate points 701, 703, and a user selection of the intermediate route 200.

In step S03, upon receipt of the input signal, the processor 4 moves the priority ones of the intermediate points 701, 703 to the front in the queue stored in the storage device 5. Then, the processor 4 plans a modified route 202 (see FIG. 5) to include the intermediate route 200 from the intermediate point 701 to the intermediate point 703 according to the queue and the user selections indicated by the input signal. The modified route 202 passes sequentially through the departure point 700, the priority ones of the intermediate points 701, 703 in the selection order, the remaining ones of the intermediate points 702, 704 and the destination 705.

In step S04, the output device 3 displays the modified route 202 on the map 100.

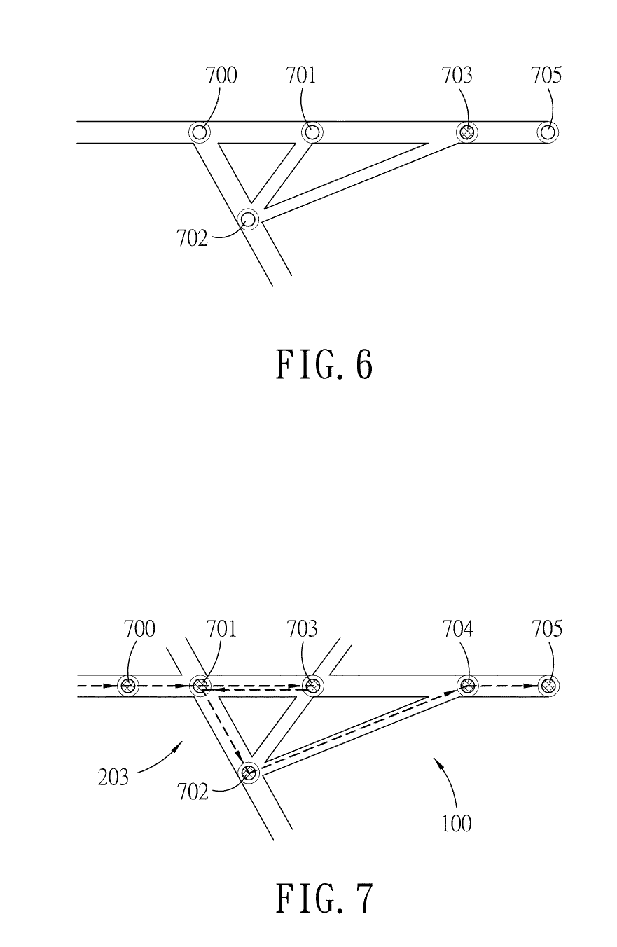

Further referring to FIGS. 6 and 7, another case where the user only selects the intermediate point 703 as the priority one is illustrated. In this case, the input device 2 generates, in step S02, an input signal in response to a user selection of the intermediate point 703 as the priority one of the intermediate points 701-704. In step S03, the processor 4 moves the priority one of the intermediate points 703 to the front in the queue, and then plans a modified route 203 passing sequentially through the departure point 700, the priority one of the intermediate points 703, the remaining ones of the intermediate points 701, 702, 704 and the destination 705. Finally, the output device 2 displays the modified route 203 on the map 100.

By this way, the user can simply select priority one(s) of intermediate points 701-704 via the input device 3, and the processor 4 plans the modified route according to the user selection(s).

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A route planning method to be implemented by a route planning system, the route planning system including a storage device, an input device, an output device, and a processor electrically connected to the input device, the output device and the storage device, the method comprising the steps of:
a) displaying, by the output device, a map and an original route from a departure point to a destination through at least two intermediate points on the map, the intermediate points being selected from a plurality of points of interest that are pre-stored in the storage device;
b) transmitting, by the input device, an input signal to the processor in response to a user selection of a priority one of the intermediate points;
c) upon receipt of the input signal, planning, by the processor, a modified route passing sequentially through the departure point, the priority one of the intermediate points, the remaining one (s) of the intermediate points and the destination; and
d) displaying, by the output device, the modified route on the map.

2. The route planning method as claimed in claim 1, wherein:
in step a), the output device displays the original route passing through more than two intermediate points between the departure point and the destination;
in step b), the input device transmits the input signal to the processor in response to a plurality of user selections respectively of multiple priority ones of the intermediate points; and
in step c), the processor plans the modified route passing sequentially through the departure point, the priority ones of the intermediate points, the remaining one (s) of the intermediate points, and the destination.

3. The route planning method as claimed in claim 2, wherein, in step b), the input signal indicates a selection order of the user selections of the priority ones of the intermediate points, and in step c), the processor plans the modified route passing through the priority ones of the intermediate points in the selection order.

4. The route planning method as claimed in claim 3, wherein, in step b), the input signal further indicates a user selection of an intermediate route that passes sequentially through the priority ones of the intermediate points, and in step c), the processor plans the modified route to include the intermediate route.

5. The route planning method as claimed in claim 4, the input device and the output device being integrated into a touch screen,
wherein, in step b), the input device transmits the input signal upon detecting continuous contact with the input device moving through multiple ones of the intermediate points along a motion path, the multiple ones of the intermediate points are selected as the priority ones of the intermediate points, and a route segment on the map corresponding to the motion path of the contact serves as the intermediate route.

6. A route planning system comprising:
a storage device configured to store a plurality of points of interest;
an output device configured to display a map, and an original route from a departure point to a destination through at least two intermediate points on the map, the intermediate points being selected from the points of interest;
an input device configured to allow a user selection of a priority one of the intermediate points, and to generate an input signal in response to the user selection; and
a processor electrically connected to said input device and said output device, and configured to, upon receipt of the input signal from said input device, plan a modified route passing sequentially through the departure point, the priority one of the intermediate points, the remaining one(s) of the intermediate points and the destination.

7. The route planning system as claimed in claim 6, wherein said storage device is configured to store the intermediate points in a queue, and said processor is further electrically connected to said storage device, and is further configured to move the priority one of the intermediate points to the front in the queue, and plan the modified route according to the queue.

8. The route planning system as claimed in claim 6, wherein, when the original route passes through more than two intermediate points between the departure point and the destination, and when the input signal indicates a plurality of user selections respectively of multiple priority ones of the intermediate points, said processor is configured to plan the modified route passing sequentially through the departure point, the priority ones of the intermediate points, the remaining one (s) of the intermediate points, and the destination.

9. The route planning system as claimed in claim 8, wherein, the input signal further indicates a selection order of the user selections of the priority ones of the intermediate points, and said processor is configured to plan the modified route passing through the priority ones of the intermediate points in the selection order.

10. The route planning system as claimed in claim 9, wherein, when the input signal further indicates a user selection of an intermediate route that passes sequentially through the priority ones of the intermediate points, said processor is configured to plan the modified route to include the intermediate route.

11. The route planning system as claimed in claim 10, wherein said input device is a sensing layer of a touch screen, and is configured to generate the input signal upon detecting continuous contact with said input device moving through multiple ones of the intermediate points along a motion path, the multiple ones of the intermediate points being selected as the priority ones of the intermediate points, a route on the map that corresponds to the motion path of the contact serving as the intermediate route.
